(19) United States
(12) Patent Application Publication
(10) Pub. No.: US 2025/0326222 A1
(43) Pub. Date: Oct. 23, 2025

(54) FILM TEARING DEVICE

(71) Applicants: HONGFUJIN PRECISION ELECTRONICS (ZHENGZHOU) CO., LTD., Zhengzhou (CN); HON HAI PRECISION INDUSTRY CO., LTD., New Taipei (TW)

(72) Inventors: LEI WANG, Zhengzhou (CN); YONG DING, Zhengzhou (CN); YONG WEI, Zhengzhou (CN); ZHI-MIN JIN, Zhengzhou (CN); JUN-FENG ZHU, Zhengzhou (CN)

(21) Appl. No.: 19/076,006

(22) Filed: Mar. 11, 2025

(30) Foreign Application Priority Data
Apr. 22, 2024 (CN) 202410488316.3

(51) Int. Cl. B32B 43/00; B25J 15/00; B25J 15/06

(52) U.S. Cl. CPC B32B 43/006; B25J 15/0066; B25J 15/0616

(57) ABSTRACT

A film tearing device for tearing a protective film from a workpiece comprises a sucking component, a clamping component, and a drive component. The sucking component is configured for lifting a tongue of the protective film from the workpiece, and the tongue is separate from the workpiece. The clamping component is configured for clamping the tongue lifted by the sucking component. The drive component is configured for moving the sucking component and the clamping component. After the clamping component clamps the tongue, the drive component moves the clamping component and the tongue, to tear the protective film off from the workpiece. By lifting tongue from the workpiece in advance, it is helpful to reduce the probability of the clamping component and the workpiece coming into contact, thereby reducing the probability of the workpiece being scratched.

### FIELD

The subject matter herein generally relates to film tearing technologies, and more particularly relates to a film tearing device.

### BACKGROUND

It is often necessary to stick a protective film on surfaces of workpieces, to reduce the risk of scratches during transportation. The workpieces may be, for example, screens or shells of electronic devices. Before assembling the workpieces into a product, the protective film needs to be torn off from the workpieces. Usually, the protective film is torn off by a clamp, and the clamp may scratch the surfaces of the workpieces. Therefore, there is room for improvement in the art.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a top view of an embodiment of a workpiece with protective films according to the present disclosure.

FIG. 2 is an isometric view of an embodiment of a film tearing device according to the present disclosure.

FIG. 3 is an isometric view of an embodiment of a sucking component and a clamping component according to the present disclosure.

FIG. 4 is an isometric view of the clamping component shown in FIG. 3.

FIG. 5 is similar to FIG. 4 but viewed from another aspect.

FIG. 6 is an enlarged view of area “A” shown in FIG. 4.

FIG. 7 is an exploded view of the sucking component and the clamping component shown in FIG. 3.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, baffle structures, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one”.

The term “comprising” means “including, but not necessarily limited to” and it specifically indicates open-ended inclusion or membership in a so-described combination, group, series, and the like.

Without a given definition otherwise, all terms used have the same meaning as commonly understood by those skilled in the art. The terms used herein in the description of the present disclosure are for the purpose of describing specific embodiments only, and are not intended to limit the present disclosure.

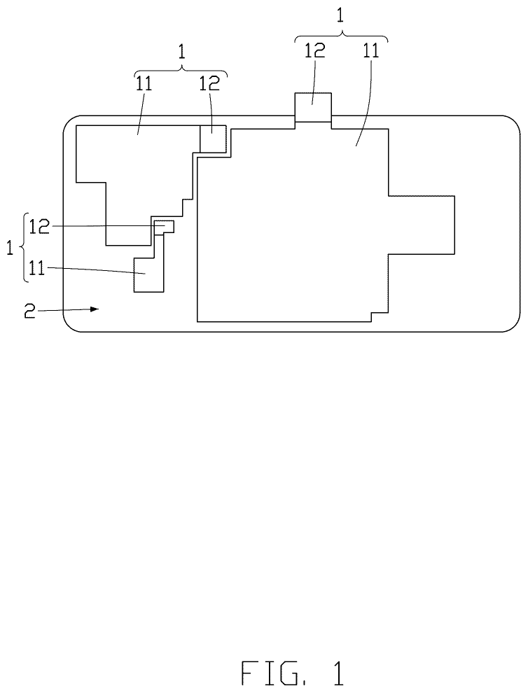

As shown in FIG. 1, a protective film 1 in an embodiment includes a film body 11 and a tongue 12 connected to the film body 11, and the tongue 12 is defined as a part of the protective film 1. A surface of the film body 11 is coated with adhesive, and the film body 11 can be stuck by the adhesive to the area of a workpiece 2 to be protected. The tongue 12 is separated the workpiece 2. The film body 11 can be torn off from the workpiece 2 by tearing the tongue 12. In another embodiment, the tongue 12 can be removed from the protective film 1, and the film body 11 can be torn off from the workpiece 2 by tearing the edge of the film body 11, so the edge of the film body 11 is defined as a part of the protective film 1 in this embodiment. The following embodiments are based on the embodiment of the protective film 1 including the film body 11 and the tongue 12.

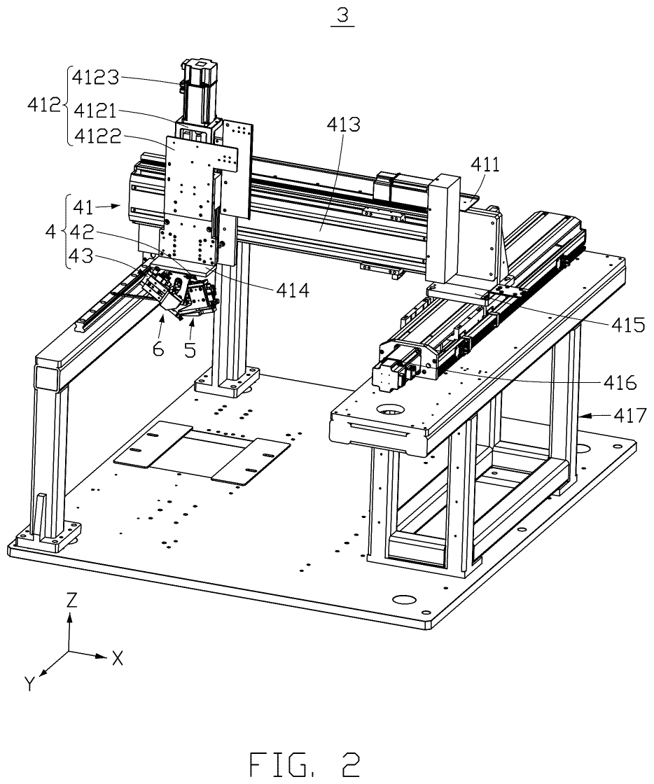

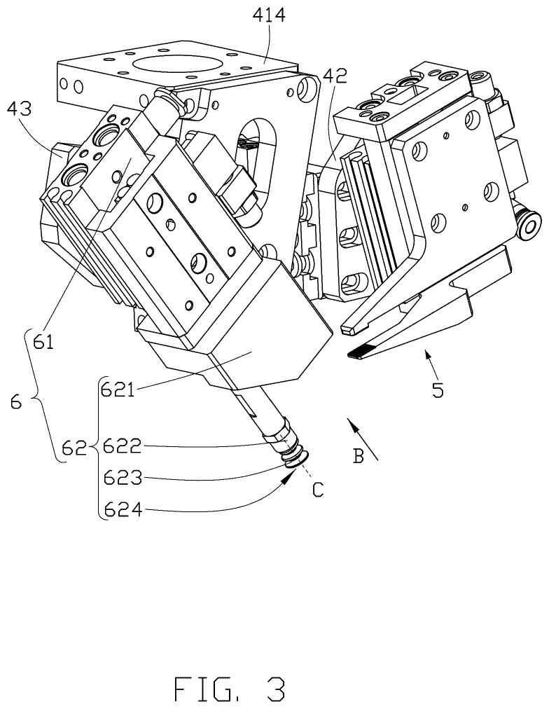

As shown in FIG. 2 and FIG. 3, a film tearing device 3 is provided in an embodiment, and the film tearing device 3 includes a drive component 4, a clamping component 5 and a sucking component 6. The sucking component 6 is configured for sucking the tongue 12 and lifting the tongue 12 up from the workpiece 2. The clamping component 5 is mounted on the drive component 4, and the clamping component 5 is configured for clamping the tongue 12 lifted by the sucking component 6. The drive component 4 is configured for moving the clamping component 5 to tear off the protective film 1 from the workpiece 2. Because the tongue 12 is lifted by the sucking component 6 before the tongue 12 is clamped by the clamping component 5, the film tearing device 3 can reduce the probability of scratching the surface of the workpiece 2 by the clamping component 5 when tearing the protective film 1.

As shown in FIG. 2 and FIG. 3, in some embodiments, the drive component 4 includes a conveyer 41, a clamp-adjusting component 42, and a suck-adjusting component 43. The clamp-adjusting component 42 connects the clamping component 5 and the conveyer 41, and the clamp-adjusting component 42 is configured for adjusting position of the clamping component 5 relative to the conveyer 41. The suck-adjusting component 43 connects the sucking component 6 and the conveyer 41, and the suck-adjusting component 43 is configured for adjusting position of the sucking component 6 relative to the conveyer 41. The conveyer 41 is configured for moving the clamp-adjusting component 42 and the suck-adjusting component 43 together. After the sucking component 6 and the clamping component 5 get close to the workpiece 2, the sucking component 6 sucks the tongue 12 and lifts the tongue 12 up from the workpiece 2, then the clamping component 5 clamps the tongue 12 lifted by the sucking component 6, at last the conveyer 41 moves the clamp-adjusting component 42 and the clamping component 5 away from the workpiece 2, to tear off the film body 11 from the workpiece 2.

In some embodiments, the conveyer 41 includes a beam 411, a sliding bracket 412, a first horizontal drive 413, and an installing frame 414. The installing frame 414 is fixed to the sliding bracket 412, the beam 411 extends along a first horizontal direction X, and the sliding bracket 412 is slidably mounted on the beam 411 in the first horizontal direction X. The first horizontal drive 413 is a linear actuator which is configured for moving the sliding bracket 412 to slide along the first horizontal direction X, and the installing frame 414 moves with the sliding bracket 412. The clamp-adjusting component 42 and the suck-adjusting component 43 are mounted on the installing frame 414, so the sucking component 6 and the clamping component 5 move with the sliding bracket 412. In some embodiments, the sliding bracket 412 includes a bracket body 4121, a lift seat 4122, and a lifting drive 4123. The bracket body 4121 is slidably mounted on the beam 411. The lifting drive 4123 is a linear actuator, and the lifting drive 4123 is configured for moving the lift seat 4122 in a vertical direction Z. The installing frame 414 is fixed on the lift seat 4122, so the installing frame 414 moves with the lift seat 4122 in the vertical direction Z.

In some embodiments, the conveyer 41 further includes a moving base 415, a second horizontal drive 416, and a support 417. The moving base 415 is slidably mounted on the support 417 along a second horizontal direction Y, the second horizontal direction Y is perpendicular to the first horizontal direction X. The beam 411 is fixed to the moving base 415, the second horizontal drive 416 is a linear actuator which is configured for moving the moving base 415 along the second horizontal direction Y, so the sucking component 6 and clamping component 5 can remove protective films 1 in different positions on the workpiece 2.

In some embodiments, the drive component 4 can be an industrial robot, the clamping component 5 and the sucking component 6 are mounted on a manipulator of the industrial robot.

As shown in FIG. 3, in some embodiments, the sucking component 6 includes a suck drive 61 and a suck module 62. The suck module 62 is mounted on the suck drive 61, and the suck module 62 is configured for sucking the tongue 12 by vacuum. The suck drive 61 is configured for moving the suck module 62 in a direction B, and the direction B is inclined relative to the protective film 1, so the tongue 12 can be tilted up from the workpiece 2, and the clamping component 5 clamps the edge of the tongue 12 tilted up by the suck module 62, which makes it easier to clamp the tongue 12. Specifically, the suck drive 61 is a cylinder or a linear actuator.

In some embodiments, the suck module 62 includes a vacuum block 621, a vacuum pipe 622, and a sucker 623. The sucker 623 is connected to the vacuum pipe 622, and the vacuum pipe 622 is connected to the vacuum block 621, the vacuum block 621 is connected to the suck drive 61. The vacuum block 621 is hollow inside for forming a negative pressure, so that the sucker 623 sucks the tongue 12. In some embodiments, the sucker 623 and the vacuum pipe 622 are integrally formed.

In some embodiments, the sucker 623 defines a mouth 624 for sucking the tongue 12, and the mouth 624 is parallel to the tongue 12 when the mouth 624 sucks the tongue 12, so the mouth 624 fully contacts the tongue 12, and the sucker 623 holds the tongue 12 more steadily, reducing the probability of the sucker 623 failing to hold the tongue 12.

Furthermore, the vacuum pipe 622 is elastic, for example, the vacuum pipe 622 is bellows, and the axis of the vacuum pipe C is parallel to the direction B in natural state. When the sucker 623 and the tongue 12 contacts, the vacuum pipe 622 deforms so that the mouth 624 becomes parallel to the tongue 12.

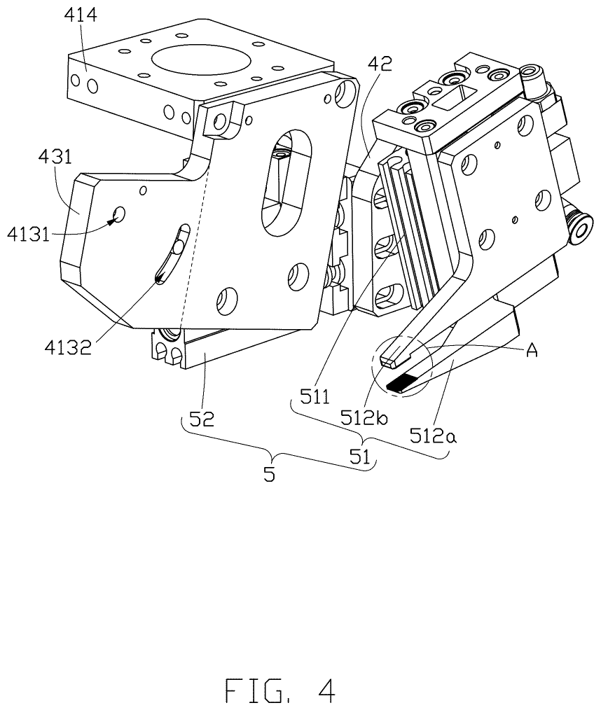

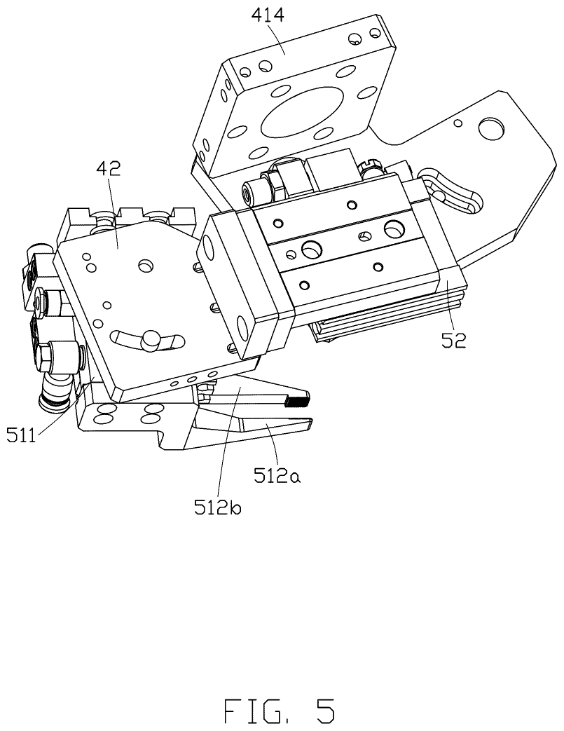

As shown in FIG. 4 and FIG. 5, in some embodiments, the clamping component 5 includes a clamp module 51 and a clamp drive 52. The clamp module 51 is mounted on the clamp drive 52. The clamp module 51 is configured for clamping the tongue 12. The clamp drive 52 is mounted on the drive component 4, the clamp drive 52 is configured for moving the clamp module 51 close to or away from the sucking component 6. The drive component 4 is configured for moving the clamp drive 52. Specifically, the clamp drive 52 is a cylinder and is mounted on the installing frame 414, the clamp module 51 is mounted on the clamp-adjusting component 42, and the clamp drive 52 is configured for moving the clamp-adjusting component 42, so the clamp module 51 moves with the clamp-adjusting component 42. For example, the clamp drive 52 is a cylinder or a linear actuator, or other drives which are not limited in this application.

In some embodiments, the clamp module 51 includes a clamp cylinder 511, a fixed claw 512a, and a movable claw 512b. The fixed claw 512a is fixed on the clamp-adjusting component 42. The clamp cylinder 511 is mounted on the clamp-adjusting component 42 and the clamp cylinder 511 is configured for moving the movable claw 512b close to or away from the fixed claw 512a, so the fixed claw 512a and the movable claw 512b can clamp or release the tongue 12. When clamping the tongue 12, the fixed claw 512a is on the side of the tongue 12 facing the workpiece 2, and the movable claw 512b is on the side of the tongue 12 opposite to the workpiece 2, so the movable claw 512b cannot contact the workpiece 2 during the movement, reducing the probability of scratching the surface of the workpiece 2. For example, the clamp cylinder 511 can be replaced by a linear actuator, or other drives which are not limited in this application.

As shown in FIG. 4 to FIG. 6, in some embodiments, the fixed claw 512a has a fixed clamping surface 512a1 and a fixed bevel 512a2 on opposite sides of the fixed claw 512a, and the movable claw 512b has a movable clamping surface 512b1 and a movable bevel 512b2 on opposite sides of the movable claw 512b. The fixed clamping surface 512a1 and the movable clamping surface 512b1 face each other and are configured for clamping the tongue 12. The distance between the fixed clamping surface 512a1 and the fixed bevel 512a2 gradually decreases, and the distance between the movable clamping surface 512b1 and the movable bevel 512b2 gradually decreases, so the ends of the fixed claw 512a and the movable claw 512b is pointed, reducing the probability of scratching the surface of the workpiece 2.

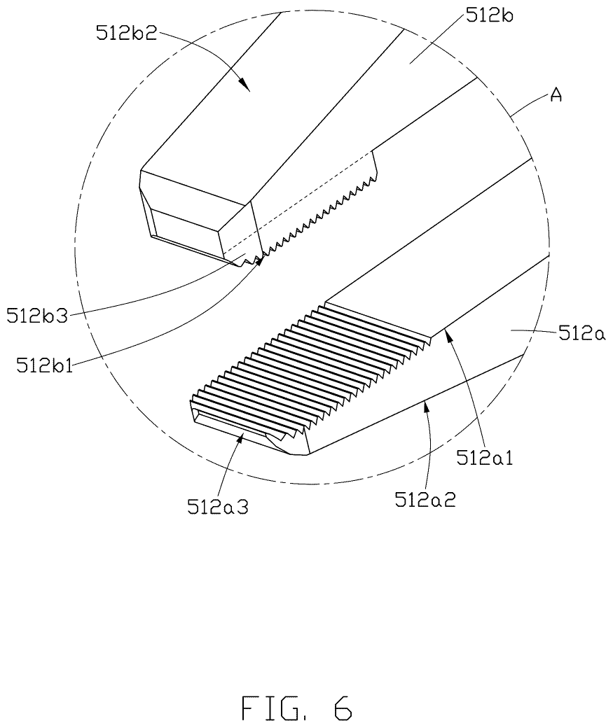

As shown in FIG. 6, in some embodiments, the movable claw 512b has a protrusion 512b3 at the movable clamping surface 512b1. Because of the protrusion 512b3, a gap is formed between the movable claw 512b and the fixed claw 512a when the fixed clamping surface 512a1 and the movable clamping surface 512b1 clamp the tongue 12, which makes the movable claw 512b and the fixed claw 512a fully contact, improving the stability of the tongue 12 clamped by the movable claw 512b and the fixed claw 512a.

As shown in FIG. 6, in some embodiments, the fixed claw 512a has a curved corner 512a3 at the pointed end of the fixed claw 512a, the curved corner 512a3 is connected between the fixed clamping surface 512a1 and the fixed bevel 512a2, the curved corner 512a3 reduces the probability of scratching the workpiece 2 by the fixed claw 512a.

As shown in FIG. 4 to FIG. 6, in some embodiments, the fixed clamping surface 512a1 and the movable clamping surface 512b1 both have anti-slip teeth, the anti-slip teeth is configured for clamping the tongue 12, improving the stability of the tongue 12 clamped by the movable claw 512b and the fixed claw 512a. Specifically, the anti-slip teeth are V-shaped grooves. Furthermore, in some embodiments, an anti-stick layer is sprayed on surface of the anti-slip teeth, and specifically, anti-stick layer is PTFE (Polytetrafluoroethylene) layer.

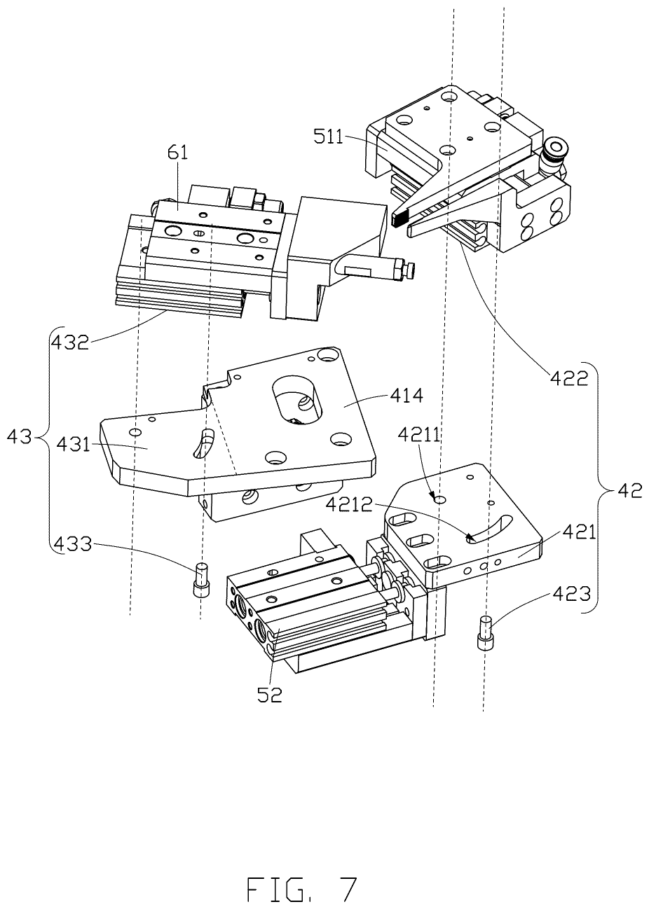

As shown in FIG. 7, in some embodiments, the clamp-adjusting component 42 includes a clamp-mounting plate 421, a clamp-rotating piece 422, and a clamp-positioner 423. The clamp-rotating piece 422 is mounted on the clamp module 51. The clamp-mounting plate 421 is mounted on the clamp drive 52. The clamp-rotating piece 422 and the clamp-mounting plate 421 are rotatably connected, and the clamp-positioner 423 is configured for positioning the clamp-rotating piece 422 relative to the clamp-mounting plate 421.

Furthermore, the clamp-mounting plate 421 has a clamp-shaft hole 4211 and a clamp-arc groove 4212. A clamp-shaft (not shown in Figs) is placed in the clamp-shaft hole 4211 and the clamp-rotating piece 422 is rotatable around the clamp-shaft. The clamp-arc groove 4212 extends around the clamp-shaft hole 4211. The clamp-rotating piece 422 and the clamp cylinder 511 are integrally formed. The clamp-rotating piece 422 has a threaded hole (not shown in Figs), the clamp-positioner 423 is a screw, the screw extends through the clamp-arc groove 4212 and inserts into the threaded hole, and the screw is slidable in the clamp-arc groove 4212. By tightening the clamp-positioner 423, the clamp-rotating piece 422 and the clamp-mounting plate 421 can be pressed against each other, so that the clamp-rotating piece 422 is fixed relative to the clamp-mounting plate 421.

In some embodiments, the clamp-adjusting component 42 may also be a structure such as a slide rail and a slide seat are slidably matched, to allow adjustment of the position of the clamping component 5, as long as the clamp-adjusting component 42 can adjust the position of the clamping component 5.

As shown in FIG. 7, in some embodiments, the suck-adjusting component 43 includes a suck-mounting plate 431, a suck-rotating piece 432, and a suck-positioner 433. The suck-mounting plate 431 and the installing frame 414 are integrally formed. The suck-rotating piece 432 and the suck drive 61 are integrally formed. The suck-rotating piece 432 is rotatable relative to the suck-mounting plate 431, and the suck-positioner 433 is configured for positioning the suck-rotating piece 432 relative to the suck-mounting plate 431.

Furthermore, the suck-mounting plate 431 has a suck-shaft hole 4311 and a suck-arc groove 4312, the suck-arc groove 4312 extends around the suck-shaft hole 4311. A suck-shaft (not shown in Figs) is placed in the suck-shaft hole 4311 and the suck-rotating piece 432 is rotatable around the suck-shaft. The suck-rotating piece 432 has a threaded hole (not shown in Figs), the suck-positioner 433 is a screw, the screw extends through the suck-arc groove 4312 and inserts into the threaded hole, and the screw is slidable in the suck-arc groove 4312. By tightening the suck-positioner 433, the suck-rotating piece 432 and the suck-mounting plate 431 can be pressed against each other, so that the suck-rotating piece 432 is fixed relative to the suck-mounting plate 431.

In some embodiments, the suck-adjusting component 43 may also be a structure such as a slide rail and a slide seat are slidably matched, to allow adjustment of the position of the sucking component 6, as long as the suck-adjusting component 43 can adjust the position of the sucking component 6.

When tearing the protective film 1, the film tearing device 3 firstly lifts the tongue 12 by the sucking component 6 to separates the tongue 12 from the workpiece 2, then the clamping component 5 approaches the sucking component 6 and clamps the tongue 12, meanwhile the sucking component 6 releases the tongue 12, then the drive component 4 drives the clamping component 5 to move, to tear off the protective film 1 from the workpiece 2. By lifting tongue 12 from the workpiece 2 in advance, it is helpful to reduce the probability of the clamping component 5 and the workpiece 2 coming into contact, thereby helping to reduce the probability of the workpiece 2 being scratched.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims.

What is claimed is:

1. A film tearing device configured for tearing a protective film from a workpiece, the film tearing device comprising:
a drive component;
a sucking component connected to the drive component and configured for sucking a part of the protective film and separating the part of the protective film from the workpiece; and
a clamping component connected to the drive component and configured for clamping the part of the protective film separated from the workpiece,
wherein after the clamping component clamps the part of the protective film, the drive component moves the clamping component, and the part of the protective film moves with the clamping component, to tear the protective film off from the workpiece.

2. The film tearing device of claim 1, wherein the sucking component comprises a suck drive and a suck module, the suck module is mounted on the suck drive, the suck module is configured for sucking and holding the part of the protective film by negative pressure, the suck drive is mounted on the drive component, the suck drive is configured for moving the suck module in a direction, the direction is inclined relative to a surface of the workpiece to lift the part of the protective film from the workpiece.

3. The film tearing device of claim 2, wherein the suck module comprises a vacuum block, a vacuum pipe, and a sucker, the vacuum block is mounted on the suck drive, the vacuum pipe connects the sucker and the vacuum block, the vacuum block is hollow inside, the negative pressure is generated inside of the vacuum block, such that the sucker sucks and holds the part of the protective film.

4. The film tearing device of claim 3, wherein the sucker defines a mouth configured for sucking the part of the protective film, and the mouth is configured to be parallel to the part of the protective film when the mouth sucks the part of the protective film.

5. The film tearing device of claim 4, wherein the vacuum pipe is elastic, an axis of the vacuum pipe is configured to be inclined relative to the part of the protective film before the mouth contacts the part of the protective film, and when the mouth contacts the part of the protective film, the vacuum pipe deforms such that the mouth is parallel to the part of the protective film.

6. The film tearing device of claim 1, wherein the clamping component comprises a clamp module and a clamp drive, the clamp module is mounted on the clamp drive, the clamp module is configured for clamping the part of the protective film, the clamp drive is mounted on the drive component, the clamp drive is configured for moving the clamp module towards the part of the protective film.

7. The film tearing device of claim 6, wherein the clamp module comprises a clamp cylinder, a fixed claw and a movable claw, the fixed claw is fixed relative to the clamp drive, the clamp cylinder is configured for moving the movable claw, the fixed claw and the movable claw are configured for clamping the part of the protective film, when clamping the part of the protective film, the fixed claw is on a side of the part of the protective film facing the workpiece, and the movable claw is on a side of the part of the protective film opposite to the workpiece.

8. The film tearing device of claim 7, wherein the fixed claw comprises a fixed clamping surface and a fixed bevel on opposite sides, the movable claw comprises a movable clamping surface and a movable bevel on opposite sides, the fixed clamping surface and the movable clamping surface face each other and are configured for clamping the part of the protective film, a distance between the fixed clamping surface and the fixed bevel gradually decreases, and a distance between the movable clamping surface and the movable bevel gradually decreases.

9. The film tearing device of claim 8, wherein the movable claw comprises a protrusion at the movable clamping surface.

10. The film tearing device of claim 8, wherein the fixed claw comprises a curved corner at a pointed end of the fixed claw, the curved corner is connected between the fixed bevel and the fixed clamping surface.

11. The film tearing device of claim 8, wherein the fixed clamping surface and the movable clamping surface comprise anti-slip teeth, the anti-slip teeth are configured for clamping the part of the protective film, an anti-stick layer is sprayed on surface of the anti-slip teeth.

12. The film tearing device of claim 1, wherein the drive component comprises a conveyer and a clamp-adjusting component, the clamp-adjusting component is mounted on the conveyer, the clamping component is connected to the clamp-adjusting component, the clamp-adjusting component is configured for adjusting position of the clamping component relative to the sucking component, the conveyer is configured for moving the clamp-adjusting component, the clamping component, and the sucking component.

13. The film tearing device of claim 12, wherein the clamp-adjusting component comprises a clamp-mounting plate, a clamp-rotating piece, and a clamp-positioner, the clamp-mounting plate is configured for mounting the clamp-adjusting component to the conveyer, the clamping component is fixed on the clamp-rotating piece, the clamp-rotating piece is rotatable relative to the clamp-mounting plate, the clamp-positioner is configured for positioning the clamp-rotating piece on the clamp-mounting plate.

14. The film tearing device of claim 13, wherein the clamp-mounting plate comprises a clamp-shaft hole and a clamp-arc groove, the clamp-arc groove extends around the clamp-shaft hole, a clamp-shaft is placed in the clamp-shaft hole and the clamp-rotating piece is rotatable around the clamp-shaft, the clamp-positioner extends through the clamp-arc groove and inserts into a threaded hole of the clamp-rotating piece.

15. The film tearing device of claim 12, wherein the drive component further comprises a suck-adjusting component, and the suck-adjusting component is mounted on the conveyer, the sucking component is connected to the suck-adjusting component, the suck-adjusting component is configured for adjusting position of the sucking component relative to the clamping component.

16. The film tearing device of claim 15, wherein the suck-adjusting component comprises a suck-mounting plate, a suck-rotating piece, and a suck-positioner, the suck-mounting plate is configured for mounting the suck-adjusting component to the conveyer, the sucking component is fixed on the suck-rotating piece, the suck-rotating piece is rotatable relative to the suck-mounting plate, the suck-positioner is configured for positioning the suck-rotating piece on the suck-mounting plate.

17. The film tearing device of claim 16, wherein the suck-mounting plate comprises a suck-shaft hole and a suck-arc groove, the suck-arc groove extends around the suck-shaft hole, a suck-shaft is placed in the suck-shaft hole and the suck-rotating piece is rotatable around the suck-shaft, the suck-positioner extends through the suck-arc groove and inserts into a threaded hole of the suck-rotating piece.

18. The film tearing device of claim 15, wherein the conveyer comprises a beam, a sliding bracket, a first horizontal drive, and an installing frame, the installing frame is fixed on the sliding bracket, the beam extends in a first horizontal direction, the sliding bracket is slidable along the beam, the first horizontal drive is configured for moving the sliding bracket slide along the beam, and the installing frame moves with the sliding bracket, the clamp-adjusting component and the suck-adjusting component are mounted on the installing frame.

19. The film tearing device of claim 18, wherein the conveyer further comprises a moving base, a second horizontal drive, and a support, the moving base is on the support and is slidable in a second horizontal direction, the second horizontal direction is perpendicular to the first horizontal direction, the beam is mounted on the moving base, the second horizontal drive is configured for moving the moving base along the second horizontal direction, and the beam moves with the moving base.

20. The film tearing device of claim 18, wherein the sliding bracket comprises a bracket body, a lift seat, and a lifting drive, the bracket body is slidably mounted on the beam, the lifting drive is configured for moving the lift seat in a vertical direction, the installing frame is fixed on the lift seat and moves with the lift seat along the vertical direction.
